(19) United States
(12) Patent Application Publication
(10) Pub. No.: US 2010/0025153 A1
(43) Pub. Date: Feb. 4, 2010

(54) ACCESSORY HOLDING DEVICE FOR LADDER ASSEMBLY

(76) Inventor: Jeffrey Decker, Gardena, CA (US)

Correspondence Address: JAY M. SCHLOFF, 6960 Orchard Lake Road, Suite 315, West Bloomfield, MI, 48322, US

(21) Appl. No.: 12/502,254

(22) Filed: Jul. 14, 2009

Related U.S. Application Data
(60) Provisional application No. 61/085,451, filed on Aug. 1, 2008.

(51) Int. Cl. E06C 5/32

(52) U.S. Cl. 182/129

(57) ABSTRACT

An accessory holding device for a ladder assembly includes a body member and at least one mounting member. The body member includes a primary compartment and a plurality of secondary compartments integrally configured with the primary compartment such that the primary compartment is disposed between a first compartment and a second compartment of the plurality of secondary compartments. The primary compartment and the plurality of secondary compartments of the body member are capable of receiving accessories therein. Further, the at least one mounting member adjustably coupled to one of the primary compartments and the plurality of secondary compartments of the body member. The at least one mounting member is capable of removably mounting the body member to the ladder assembly for holding the accessories.

### CROSS REFERENCE TO RELATED APPLICATIONS

The present disclosure claims priority under 35 United States Code, Section 119 on the U.S. Provisional Patent Application No. 61/085,451 filed on Aug. 1, 2008, the disclosure of which is incorporated by reference.

### FIELD OF THE DISCLOSURE

The present disclosure relates to accessories holding equipment and more particularly, to an accessory holding device for being utilized with a ladder assembly to receive accessories therein in order to facilitate an individual to select a desired accessory from the accessories, while performing tasks.

### BACKGROUND OF THE DISCLOSURE

Various accessories, such as paint cans, brushes, rags and tools are required by an individual while performing tasks such as painting and/or cleaning a wall. While performing such a task, handling of such accessories become cumbersome. Further, the problem of handing such accessories becomes even more cumbersome when the individual is required to stand on a ladder assembly to perform such a task. Generally, the individual may not be able to access an upper portion of the wall that is substantially high for performing such task, and therefore the individual requires the ladder assembly for performing such tasks on the upper portion of the wall. While performing such tasks from the ladder assembly, the individual may get frustrated, if he/she has to come down every time to select a desired accessory from the accessories.

In light of the aforesaid problem, open containers are often used. The individual may store the accessories in an open container, and accordingly perform such tasks while standing on the ladder assembly. However, balancing on the ladder assembly by holding the open container in one hand, and performing the tasks with other hand is quite dangerous for the individual, as the individual and container may fall due to the difficulty in maintaining balance. Further, using such an open container for receiving the accessories such as the paint cans may pose a problem. More often than not, paint from the paint may spill, when the individual loses balance while standing on the ladder assembly. Such spilling of the paint may soil a work area or a floor of a house.

Further, the accessories, such as the brushes, the rags and the tools stored in the open container may get jumbled, thereby causing inconvenience to the individual in locating the desired accessory from the accessories stored in the open container.

Accordingly, there exists a need to preclude losing balance of an individual due to holding of accessories and/or an open container, while performing tasks such as painting and/or cleaning a wall from a ladder assembly. Furthermore, there exists a need to preclude spilling of paint from a paint can, while performing tasks from the ladder assembly. Furthermore, there exists a need to preclude jumbling of accessories stored in an open container.

### SUMMARY OF THE DISCLOSURE

In view of the foregoing disadvantages inherent in the prior art, the general purpose of the present disclosure is to provide an accessory holding device for a ladder assembly to include all the advantages of the prior art, and to overcome the drawbacks inherent therein.

Accordingly, an object of the present disclosure is to preclude the loss of balance by an individual due to holding of accessories and/or an open container, while performing tasks such as painting and/or cleaning a wall from a ladder assembly.

Another object of the present disclosure is to preclude spilling of paint from a paint can, while performing the tasks from a ladder assembly.

Another object of the present disclosure is to preclude jumbling of accessories stored in an open container.

In light of the above objects, in one aspect of the present disclosure, an accessory holding device for a ladder assembly is provided. The accessory holding device includes a body member and at least one mounting member. The body member includes a primary compartment and a plurality of secondary compartments integrally configured with the primary compartment such that the primary compartment is disposed between a first compartment and a second compartment of the plurality of secondary compartments. The primary compartment and the plurality of secondary compartments of the body member are capable of receiving accessories therein. Further, the at least one mounting member adjustably coupled to one of the primary compartment and the plurality of secondary compartments of the body member for removably mounting the body member to the ladder assembly for holding the accessories.

The at least one mounting member of the accessory holding device is capable of mounting the accessory holding device to the ladder assembly, thereby keeping an individual's hands free for performing tasks such as painting and/or cleaning a wall from the ladder assembly, and avoiding a loss of the individual's balance due to holding of the accessories and/or an open container. Further, the primary compartment configured between the first compartment and the second compartment of the plurality secondary compartment is capable of receiving a paint can therein. The structure of the primary compartment is such that the paint may be securely received therein; thereby avoiding spilling of paint from the paint can due to unbalancing of the individual on the ladder assembly, while performing the tasks. Further, a plurality of secondary compartments configured to receive various accessories such as brushes, rags, tools and the like preclude jumbling of accessories.

This together with other aspects of the present disclosure, along with the various features of novelty that characterize the present disclosure, is pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawing, in which:

FIG. 1A illustrates a perspective view of a front portion of an accessory holding device, in accordance with an exemplary embodiment of the present disclosure;

FIG. 1B illustrates a perspective view of a rear portion of an accessory holding device, in accordance with an exemplary embodiment of the present disclosure; and

FIG. 2 illustrates a perspective view of an accessory holding device removably mounted to a ladder assembly, in accordance with an exemplary embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to an accessory holding device for a ladder assembly as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present disclosure provides an accessory holding device for a ladder assembly. The accessory holding device is capable of being removably mounted to the ladder assembly for enabling an individual to conveniently store and retrieve accessories such as paint cans, brushes, rags or the like while working on the ladder assembly. The accessory holding device precludes a need of holding the accessories in hand while performing tasks such as painting and/or cleaning a wall from the ladder assembly.

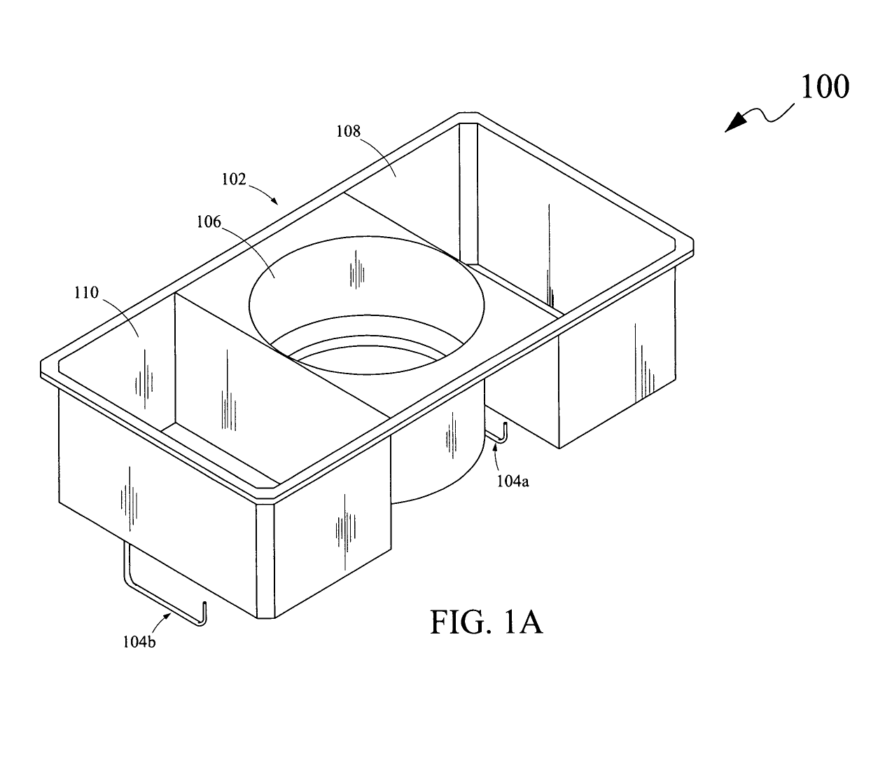

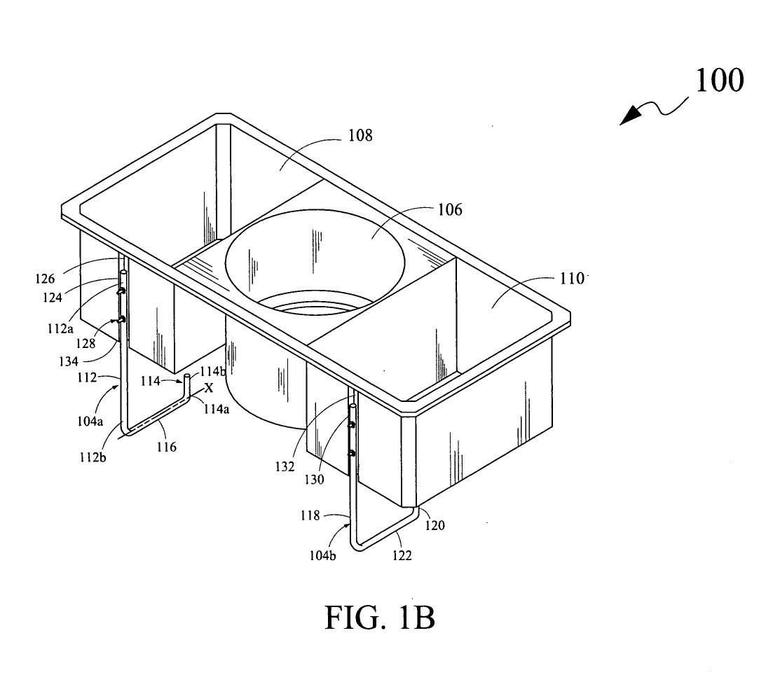

Referring now to FIG. 1A and FIG. 1B, wherein FIG. 1A illustrates a perspective top front view of an accessory holding device 100 and FIG. 1B illustrates a perspective top rear view of the accessory holding device 100 in accordance with an embodiment of the present disclosure. The accessory holding device 100 includes a body member 102 and at least one mounting member adjustably coupled to the body member 102. In FIG. 1A and FIG. 1B, the at least one mounting member is shown as two mounting members, such as a first mounting member 104a and a second mounting member 104b, according to an embodiment of the present disclosure. The first mounting member 104a and the second mounting member 104b hereinafter collectively referred to as mounting members 104. The body member 102 of the accessory holding device 100 is capable of being mounted to a ladder assembly (not shown) via the mounting members 104. The accessory holding device 100 is capable of receiving accessories (not shown), thereby facilitating an individual to perform various tasks such as painting and/or cleaning a wall from the ladder assembly.

The body member 102 includes a primary compartment 106 and a plurality of secondary compartment. In FIG. 1A and FIG. 1B, the plurality of secondary compartment is shown as two compartments, such as a first compartment 108 and a second compartment 110, according to an embodiment of the present disclosure. The first compartment 108 and the second compartment 110 of the body member 102 are integrally configured with the primary compartment 106 such that the primary compartment 106 is disposed between the first compartment 108 and the second compartment 110. However it will be evident to a person skilled in the art to arrange the primary compartment 106, the first compartment 108 and the second compartment 110 in any other manner, such as the first compartment 108 and the second compartment 110 may lie adjacent to each other, and the primary compartment 106 may lie adjacent to any one of the first compartment 108 and the second compartment 110, depending upon his/ her requirements.

The primary compartment 106, the first compartment 108 and the second compartment 110 are integrally configured to form a single unit, such as the body member 102 by a manufacturing process, such as a molding. However, it will be evident to a person skilled in the art that the primary compartment 106, the first compartment 108 and the second compartment 110 are integrally configured to form a single unit, such as the body member 102 by any other manufacturing process known in the art. Further, the primary compartment 106, the first compartment 108 and the second compartment 110 may also be configured separately and thereafter may be connected together to form a single unit, such as the body member 102. The primary compartment 106, the first compartment 108 and the second compartment 110 are capable of holding the accessories therein. More specifically, the primary compartment 106 is capable of receiving the accessories such as a paint can, a water container, and the like. Further, the first compartment 108 and the second compartment 110 are capable of receiving the accessories, such as brushes, rags and tools.

The primary compartment 106 is configured to receive the accessories that are specifically cylindrical in shape, such as the paint can, the water container. In an exemplary embodiment of the present disclosure, the primary compartment 106 is configured to include an annular shape to accommodate the paint cans and/or the water cans that are generally cylindrical in shape. The annular shape of the primary compartment 106 is capable of securely holding the paint cans and/or the water cans therein so that shaking of the accessory holding device 100 may not cause spilling of paint from the paint cans, and/or water from the water cans. However, it will be evident to a person skilled in the art that the primary compartment 106 may be configured to include any other shape such as a rectangle, a square, a polygon, and the like to accommodate the paint cans and/or the water cans of different shapes and sizes.

Further, the first compartment 108 and the second compartment 110 are configured to include one of a rectangular shape, a square shape, a polygon shape and an annular shape. According to one embodiment of the present disclosure, the first compartment 108 and the second compartment 110 are configured to have the rectangular shape for receiving the accessories such as the brushes, the rags, and the tools of different shapes and sizes. The body member 102 including the primary compartment 106, the first compartment 108 and the second compartment 110 is capable of being removably mounted to the ladder assembly via the mounting members 104 for performing tasks upon standing on the ladder assembly.

Specifically as shown in FIG. 1B, the mounting members 104 is adjustably coupled to the body member 102. More specifically, the first mounting member 104a is adjustably coupled to the first compartment 108, and the second mounting member 104b is adjustably coupled to the second compartment 110 for removably mounting the body member 102 to the ladder assembly for holding the accessories therein. However, it will be evident to a person skilled in the art to adjustably couple the mounting members 104 to any other portion, such as the primary compartment 106 of the body member 102.

The first mounting member 104a includes a first vertical member 112, a second vertical member 114 and a horizontal member 116. The first vertical member 112 includes an upper end portion 112a and a lower end portion 112b. Further, the second vertical member 114 includes a first end portion 114a and a second end portion 114b. The horizontal member 116 is capable of extending horizontally from the lower end portion 112b of the first vertical member 112 for connecting with the first end portion 114a of the second vertical member 114, such that the second end portion 114b of the second vertical member 114 lies above a horizontal axis ‘X’ of the horizontal member 116. Similar to the first mounting member 104a, the second mounting member 104b also includes a first vertical member 118, a second vertical member 120 and a horizontal member 122. The first vertical member 118, the second vertical member 120 and the horizontal member 122 are coupled to each other in a similar fashion as the first vertical member 112, the second vertical member 114 and the horizontal member 116 of the first mounting member 104a are coupled to each other, and therefore the second mounting member 104b has not been described for sake of brevity. Without departing from the scope of the present disclosure, the first mounting member 104a and the second mounting member 104b are configured to include any other shape apart from the shape described above.

The first mounting member 104a and the second mounting member 104b are configured to an outer portion of the body member 102. Specifically, the first vertical member 112 of the first mounting member 104a is adjustably coupled to an outer surface of the first compartment 108, and the first vertical member 118 of the second mounting member 104b is adjustably coupled to an outer surface of the second compartment 110.

The outer surface of the first compartment 108 includes a first vertical bracket 124 having a first longitudinal slot 126 configured thereon. The first vertical member 112 of the first mounting member 104a is disposed in the first longitudinal slot 126 to slide up and down therethrough. More specifically, the upper end portion 112a of the first vertical member 112 is disposed in the first longitudinal slot 126. The upper end portion 112a of the first vertical member 112 is capable of being locked in the first longitudinal slot 126 with the help of nut and bolt assemblies 128 at a predetermined height. Similarly, the outer surface of the second compartment 110 includes a second vertical bracket 130 having a second longitudinal slot 132 configured thereon. The first vertical member 118 of the second mounting member 104b is disposed in the second longitudinal slot 132 to slide up and down therethrough. Similar to the first mounting member 104a, the second mounting member 104b is also configured to slide up and down through the second longitudinal slot 132. The detail configuration of the second mounting member 104b has not been included for the sake of brevity.

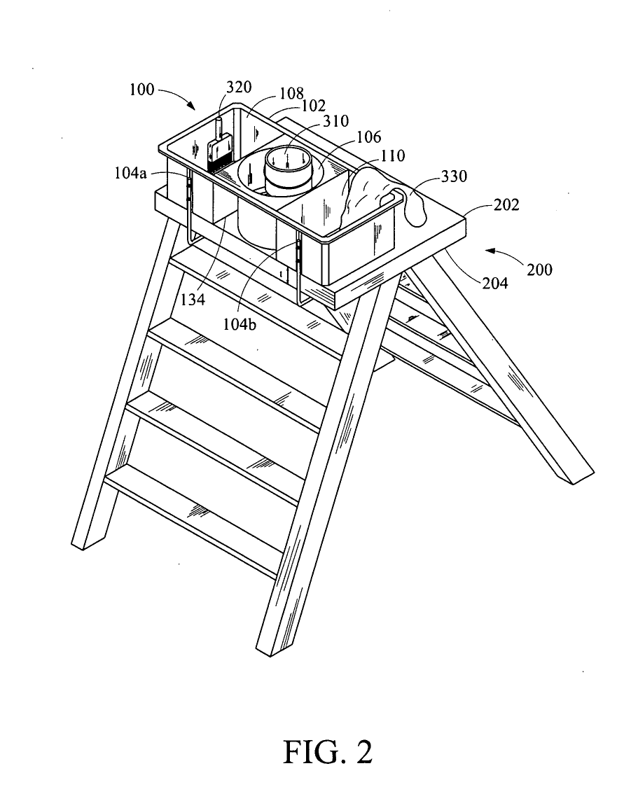

The first mounting member 104a and the second mounting member 104b may be adjusted to slide up and down along the first vertical bracket 124 and the second vertical bracket 130, respectively. The first mounting member 104a and the second mounting member 104b may be adjusted to slide up and down with respect to a lower surface 134 of the body member 102 to define a space therebetween, according to a thickness of a portion of a ladder assembly on which the accessory holding device 100 is to be mounted. The mounting of the accessory holding device 100 to the ladder assembly and utility thereof with regard to holding the accessories, will be now described herein in conjunction with FIG. 2.

Referring to FIG. 2 a perspective view of the accessory holding device 100 removably mounted on a top portion of a ladder assembly 200 is illustrated, and will be described in conjunction with FIG. 1A and FIG. 1B. The accessory holding device 100 is capable of being removably mounted on a top portion 202 of the ladder assembly 200. As shown in FIG. 2, the accessory holding device 100 is removably mounted to a typical A-frame ladder assembly known in the art; however, it will be evident to a person skilled in the art to mount the accessory holding device 100 to any other ladder assembly known in the art.

The accessory holding device 100 is mounted on the top portion 202 of the ladder assembly 200 with the help of the first mounting member 104a and the second mounting member 104b. Specifically, the mounting members 104 is capable of being slid up and down along the respective longitudinal slot, such as the first mounting member 104a is slid along the first longitudinal slot 126, and the second mounting member 104b is slid along the second longitudinal slot 132, to define a space between the lower surface 134 of the body member 102 and the mounting members 104, (specifically vertical members 114 and 120 of the mounting members 104) according to a thickness ‘t’ of the top portion 202 of the ladder assembly 200. Upon adjusting the mounting members 104 along the respective longitudinal slot to define the space according to the thickness ‘t’ of the top portion 202, the mounting members 104 is locked using nut and bolt assemblies, such as the nut and bolt assemblies 128. At a locked position of the nut and bolt assemblies, the second vertical members, such as the second vertical member 114 and the second vertical member 120 hooked below a lower surface 204 of the top portion 202. Specifically, the second end portion 114b of the second vertical member 114, and the second end portion (not shown) of the second vertical member 120 is hooked below the lower surface 204 of the top portion 202, thereby securing the accessory holding device 100 with the ladder assembly 200. The body member 102 of the accessory holding device 100 is capable of receiving accessories such as a paint can 310, a brush 320 and a rag 330, as shown in FIG. 2. The primary compartment 106 of the accessory holding device 100 is shown to receive the paint can 310 for exemplary purpose. The annular shape of the primary compartment 106 allows easy storage and retrieval of the paint can 310. Similarly, the first compartment 108 and the second compartment 110 are shown to receive the brush 320, and the rag 330 for exemplary purposes.

According to one embodiment of the present disclosure the body member 102 of the accessory holding device 100 is made of a plastic material. Without departing from the scope of the present disclosure, the body member 102 may be made of any other material, such as a metal, an alloy or any other suitable durable material. The plastic material of the body member 102 is light in weight that facilitates the individual to easily handle the accessory holding device 100. Further, the body member 102 of the accessory holding device 100 may be made of different colors so as to accommodate various individual preferences. Moreover, the mounting members 104 is made of a metal such as steel, alloy or any other suitable material which provides strength to mount the body member 102 to the ladder assembly 200, and also firmly holds the body member 102 adjustably mounted to the ladder assembly 200.

The present disclosure provides an accessory holding device, such as the accessory holding device 100, which offers the following advantages. The accessory holding device is capable of being mounted to a ladder assembly, thereby keeping an individual's hands free for performing tasks such as painting and/or cleaning a wall from a ladder assembly, and avoiding a loss of balance by the individual due to holding of the accessories and/or an open container. Further, the accessory holding device is configured to include various compartments for storing various accessories therein. For example, a primary compartment is configured to receive a paint can therein. The structure of the primary compartment is such that the paint may be securely received therein, thereby avoiding spilling of the paint from the paint can due to a loss of balance of an individual on the ladder assembly, while performing the tasks. Further, the plurality of secondary compartments is configured to receive various accessories such as brushes, rags, tools and the like preclude jumbling of accessories.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An accessory holding device for a ladder assembly, the accessory holding device comprising:
a body member, the body member comprising
a primary compartment,
a plurality of secondary compartments integrally configured with the primary compartment such that the primary compartment is disposed between a first compartment and a second compartment of the plurality of secondary compartments, the primary compartment and the plurality of secondary compartments capable of receiving accessories therein; and
at least one mounting member adjustably coupled to one of the primary compartment and the plurality of secondary compartments of the body member, wherein the at least one mounting member is capable of removably mounting the body member to the ladder assembly for holding the accessories.

2. The accessory holding device of claim 1, wherein the at least one mounting member comprises
a first vertical member and a second vertical member, a upper end portion of the first vertical member adjustably coupled to one of the primary compartment and the plurality of secondary compartments of the body member; and
a horizontal member extending horizontally from a lower end portion of the first vertical member for connecting with a first end portion of the second vertical member, such that a second end portion of the second vertical member lies above a horizontal axis of the horizontal member.

3. The accessory holding device of claim 1, wherein the primary compartment is configured to comprise an annular shape.

4. The accessory holding device of claim 1, wherein the plurality of secondary compartments is configured to comprise one of a rectangular shape, a square shape, a polygon shape and an annular shape.

5. The accessory holding device of claim 1, wherein the body member is made of a plastic material.

6. The accessory holding device of claim 1, wherein the at least one mounting member is made of metal.
